(19) United States
(12) Patent Application Publication
(10) Pub. No.: US 2013/0277079 A1
(43) Pub. Date: Oct. 24, 2013

(54) POWER TOOL

(71) Applicants: Hitoshi Tsuzuki, Hitachinaka (JP); Masato Sakai, Hitachinaka (JP)

(72) Inventors: Hitoshi Tsuzuki, Hitachinaka (JP); Masato Sakai, Hitachinaka (JP)

(73) Assignee: HITACHI KOKI CO., LTD., Tokyo (JP)

(21) Appl. No.: 13/997,517

(22) PCT Filed: Dec. 27, 2011
(86) PCT No.: PCT/JP2011/007301

§ 371 Date: Jun. 24, 2013

(30) Foreign Application Priority Data
Dec. 28, 2010 (JP) 2010-293417

(51) Int. Cl. B25F 5/00

(52) U.S. Cl. CPC B25F 5/006
USPC 173/162.2

(57) ABSTRACT

A hand-held power tool capable of reducing strain on a worker's fingers which might be caused by vibration and reaction during work is provided. A grip section, which is extending from substantially a central part in an axial direction of the body portion toward a direction substantially perpendicular to the axial direction, is integrally provided on a body portion having a motor housing. A grip housing configuring the grip section is provided so as to extend from the motor housing. The grip housing includes a housing body including a pair of housing pieces and a cover sandwiched to be held by the housing pieces. The cover includes a compression-molded article in which a resin cover body and a rubber member are integrally formed by compression molding.

### TECHNICAL FIELD

The present invention relates to a hand-held power tool in which a grip housing is provided so as to extend from a motor housing which houses a motor.

### BACKGROUND ART

A hand-held power tool such as an impact driver and a hammer drill includes: a tool holder to which tip tools such as a bit and a drill are attached; and a motor (driving source) which rotates the tool holder. The tool holder is rotatably supported on a tip of a motor housing, and the motor is housed in the motor housing. A grip section (handle) is integrally provided in a body portion configured in the above-described manner. The grip section is a portion which is gripped by a worker during work, and has a grip housing provided so as to extend from the motor housing. Moreover, a trigger for starting the motor is provided to a portion facing the tool holder at a root portion of the grip section. The work with use of this power tool is conducted by pulling the trigger in a state where the tip tool is pressed against a work member while the body portion is being held by gripping the grip section.

In such a power tool, the grip housing is provided so as to extend from the motor housing. Thus, vibration of the motor and a speed reduction mechanism, reaction from the tip tool, etc. produced during work are transmitted to the grip housing through the motor housing, thereby increasing strain on the worker's fingers.

Therefore, for example, according to a power tool disclosed in Japanese Patent Application Laid-open Publication No. 2001-198856 (Patent Literature 1), a rear portion of the grip housing, on a side opposite to a side of the grip housing where the trigger is provided, has a cover separately formed from the grip housing body. A surface of the cover is covered with an outer covering of a rubber material such as an elastomer. Thus, the vibration and reaction that occur during work are absorbed in the outer covering of the rubber material, thereby reducing strain on the worker's fingers.

### CITATION LIST

### Patent Literature

PTL 1: Japanese Patent Application Laid-open Publication No. 2001-198856

### SUMMARY OF INVENTION

### Technical Problem

However, according to conventional power tools, by two-layer injection molding (two-color injection molding), the outer covering of the rubber material is formed integrally on the surface of the resin cover. Therefore, the rubber material cannot be allowed to have an extremely uneven thickness during molding and the outer covering of the rubber material cannot be formed to have a sufficient thickness. Therefore, the hardness of the outer covering of the rubber material is only about 60 degrees, being unable to sufficiently absorb the vibration and reaction during work.

On the contrary, there is a known structure of a power tool in which a vibration absorbing material such as rubber formed separately from the grip housing is attached onto the rear-side surface of the grip housing an adhesive, etc. With the above structure, however, it is necessary to paste the vibration absorbing material onto a surface of the grip housing, thereby increasing, by as much for the extra work, the manufacturing cost of the power tool.

The present invention has been made in view of the above-mentioned problems, and a preferred aim is to provide a hand-held power tool capable of reducing strain on a worker's fingers which might be caused by vibration and reaction during work.

### Solution to Problem

According to one aspect of the present invention, a power tool of the present invention includes: a tool holder to which a tip tool is attached; a motor for driving the tool holder; a motor housing for housing the motor; and a grip housing provided so as to extend from the motor housing, in which a part of the grip housing is made of an elastic body formed by compression molding.

According to another aspect of the present invention, the grip housing includes: a first housing formed of a first resin; and a second housing made of a second resin, the second housing including an elastic body formed by compression molding, and the second housing is fixed to the first housing with a screw.

According to another aspect of the present invention, the first resin and the second resin are in direct contact with each other.

According to still another aspect of the present invention, the grip housing includes: a first housing formed by combining a pair of housing pieces and a second housing including an elastic body, and the second housing is sandwiched between the pair of housing pieces to be held by the first housing.

According to still another aspect of the present invention, the first housing and the second housing are fitted to each other.

According to still another aspect of the present invention, the elastic body is disposed so as to be able to come in contact with the first housing.

According to still another aspect of the present invention, a trigger for starting the motor is provided in the grip housing.

According to still another aspect of the present invention, a recess for housing the trigger is provided in the second housing.

According to still another aspect of the present invention, a trigger for starting the motor is provided in the grip housing.

### Advantageous Effects of Invention

According to the present invention, a part of the grip is made of an elastic body formed by compression molding, thereby allowing the elastic body to have uneven thickness. Accordingly, the thickness of the elastic body can be adjusted suitably, realizing a structure for reliably absorbing vibration, reaction, etc. that occur during work by the elastic body, being able to reduce s train on the fingers of the worker during work.

### BRIEF DESCRIPTION OF DRAWINGS

FIG. 1 is a side view of an impact driver according to an embodiment of the present invention.

FIG. 2 is a partly omitted cross-sectional view of the impact driver shown in FIG. 1.

FIG. 3A is a front view of the cover shown in FIG. 1.

FIG. 3B is a left side view of the cover shown in FIG. 1.

FIG. 3C is a back view of the cover shown in FIG. 1.

FIG. 3D is a right side view of the cover shown in FIG. 1.

FIG. 3E is a plan view of the cover shown in FIG. 1.

FIG. 3F is a bottom view of the cover shown in FIG. 1.

FIG. 4 is a vertical cross-sectional view showing details of a grip section of the impact driver shown in FIG. 1.

FIG. 5 is a cross-sectional view taken along the line A-A in FIG. 4.

FIG. 6 showing a modification of the impact driver shown in FIG. 1 is a side view showing the modified impact driver having its cover removed.

FIG. 7A is a front view of the cover shown in FIG. 6.

FIG. 7B is a left side view of the cover shown in FIG. 6.

FIG. 7C is a back view of the cover shown in FIG. 6.

FIG. 7D is a right side view of the cover shown in FIG. 6.

FIG. 7E is a plan view of the cover shown in FIG. 6.

FIG. 7F is a bottom view of the cover shown in FIG. 6.

FIG. 8 is a vertical cross-sectional view showing details of the cover of the impact driver shown in FIG. 6.

FIG. 9 is a horizontal cross-sectional view of a grip section of the impact driver shown in FIG. 6.

FIG. 10A is a side view of a D-shaped grip electric drill according to another embodiment of the present invention.

FIG. 10B is a cross-sectional view of a grip section of the D-shaped grip electric drill in FIG. 10A.

FIG. 11A is a side view of a pistol-shaped grip electric drill according to another embodiment of the present invention.

FIG. 11B is a cross-sectional view of a grip section of the pistol-shaped grip electric drill in FIG. 11A.

### DESCRIPTION OF EMBODIMENTS

Hereinafter, with reference to the drawings, an embodiment of the present invention will be described in detail.

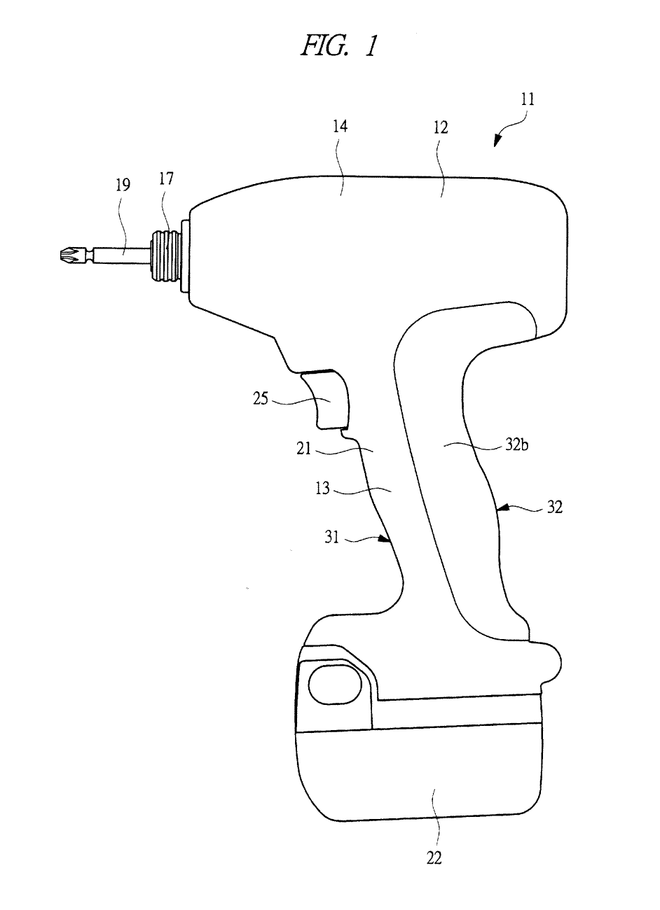

An impact driver 11 as a power tool shown in FIG. 1 is a hand-held electric power tool which is used for fastening or loosening fastening members such as screws and bolts.

The impact driver 11 includes: a body portion 12 formed in a shell-like shape; and a grip section 13 extending from about a central part in an axial direction of the body portion 12 toward a direction substantially perpendicular to the axial direction.

The outer covering of the body portion 12 includes a motor housing 14 made of a resin. The motor housing 14 houses: an electric motor 15 serving as a motor (driving source); and a speed reduction mechanism 16. A tool holder 17 such as a socket and a chuck is rotatably supported on a tip of the motor housing 14. The tool holder 17 is connected to the electric motor 15 through the speed reduction mechanism 16.

Between the speed reduction mechanism 16 and the tool holder 17, there is provided an impact mechanism part (striking mechanism) 18. In the impact mechanism 18, a first claw connected to the speed reduction mechanism 16 strikes a second claw connected to the tool holder 17 in a direction of rotation. When the electric motor 15 rotates in a forward direction, the first claw strikes the second claw. When the electric motor 15 rotates in a reverse direction and then rotates in the forward direction, the first claw strikes the second claw again. Thus, when the electric motor 15 rotates repeatedly in the forward and reverse directions, rotational force of the electric motor 15 is converted into the rotational striking power of the tool holder 17 through the impact mechanism 18. Accordingly, when the electric motor 15 is operated, the rotation of the electric motor 15 is transmitted via the speed reduction mechanism 16 and the impact mechanism 18, and the tool holder 17 is rotatably driven by the electric motor 15.

For example, a tip tool 19 such as a plus bit, a driver bit, and a hexagon bit is attached to the tool holder 17. When the electric motor 15 is operated, the tip tool 19 is rotated together with the tool holder 17, and a predetermined work is conducted.

On the other hand, the grip section 13 includes a grip housing 21 which is provided so as to extend from the motor housing 14. The grip section 13 is a portion which is gripped by a worker during work. That is, the work with use of the impact driver 11 is conducted by holding the body portion 12 by gripping the grip section 13.

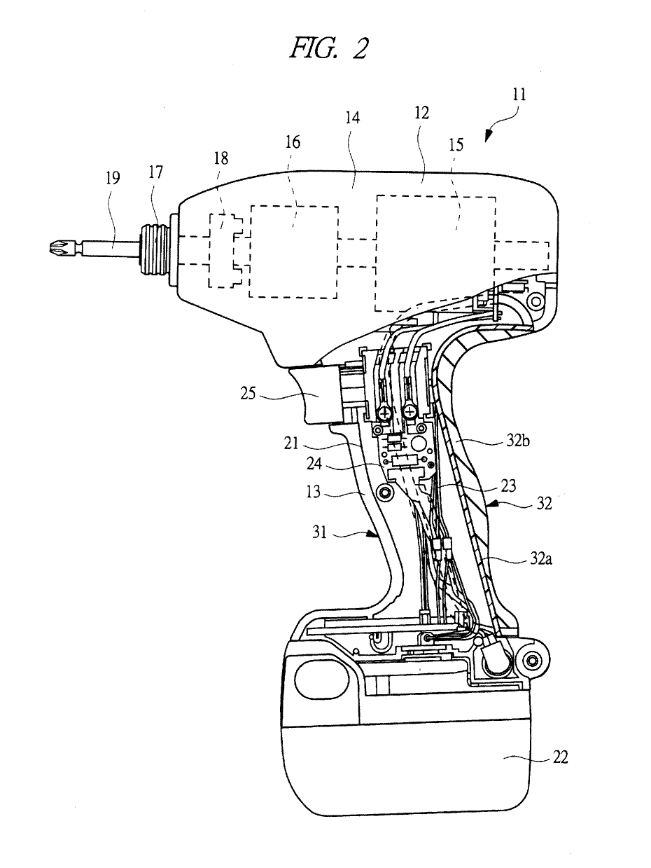

A battery pack 22 is detachably mounted in a lower end portion on the opposite side to the body portion 12 of the grip section 13. The battery pack 22 is made as a unit such that a lithium ion battery etc. is housed in a case, and is used as a power source for the electric motor 15. As shown in FIG. 2, inside the grip housing 21, a wiring 23, which connects the battery pack 22 with the electric motor 15, and a substrate 24 etc. are housed.

In a root portion which is provided so as to extend from the body portion 12 of the grip section 13, a trigger 25 projecting toward the tool holder 17 side is provided for operating the start of the electric motor 15. The trigger 25 is provided so as to freely protrude and retract in the direction of inside and outside of the grip housing 21. When it is pushed into a predetermined position towards the inner portion of the grip housing 21, the electric power of the battery pack is supplied to the electric motor 15 to start the electric motor 15 by the substrate 24.

Next, the details of the grip section 13 which is a characteristic part of the impact driver 11 will be explained.

According to the present embodiment, the grip housing 21 includes: a housing body 31 as a first housing which is formed integrally with the motor housing 14 using a resin material as a first resin; and a cover 32 as a second housing formed separately from the housing body 31. The cover 32 is held (attached) on the housing body 31. The housing body 31 configures a front half of the grip section 13 which is on the tool holder 17 (trigger 25) side. The cover 32 held on the housing body 31 configures a rear half of the grip section 13 which is on the opposite side to the tool holder 17 (trigger 25) side.

As understood from FIG. 5, the housing body 31 formed integrally with the motor housing 14 is, together with the motor housing 14, separated symmetrically (front and back in FIG. 1) about a plane which passes a center axis of the electric motor 15 and a center axis of the grip section 13. That is, the housing body 31 is formed by combining a pair of housing pieces 31a and 31b. The housing body 31 made by combining the housing pieces 31a and 31b is in a semi-cylindrical shape having its portion facing the rear side opened and the opening is closed with the cover 32. Moreover, as shown in FIG. 5, on an outer periphery of the opening of the housing body 31, to hold the cover 32, engaging projections 31c projecting inwardly with respect to the opening are provided all over the circumference.

On the other hand, the cover 32 is a compression-molded article which is made such that a resin cover body 32a as a second resin and a rubber material 32b as an elastic body are integrally formed by compression molding. The outer surface of the cover body 32a is covered with the rubber material 32b.

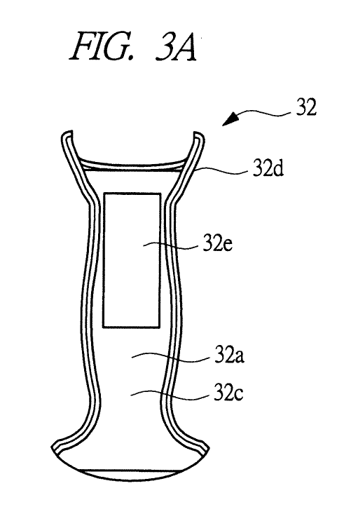

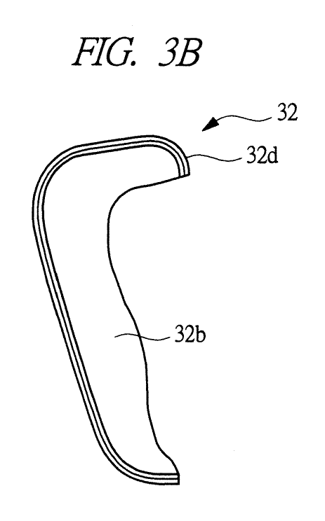

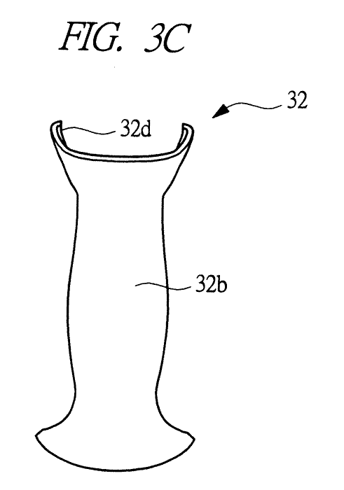

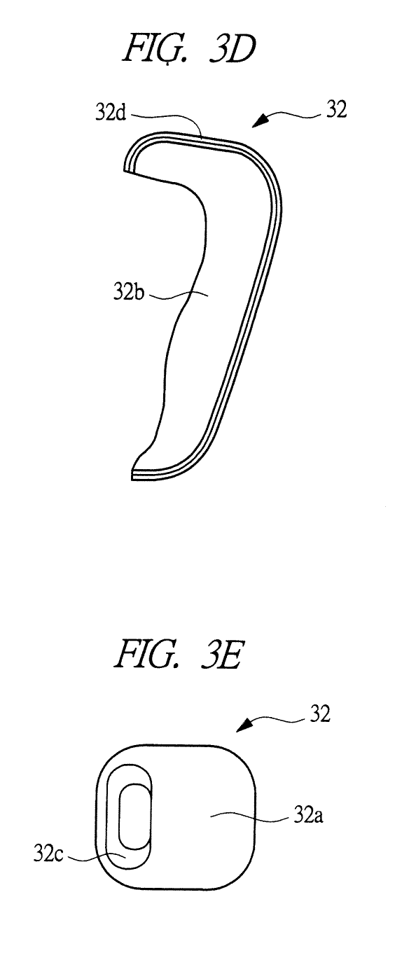

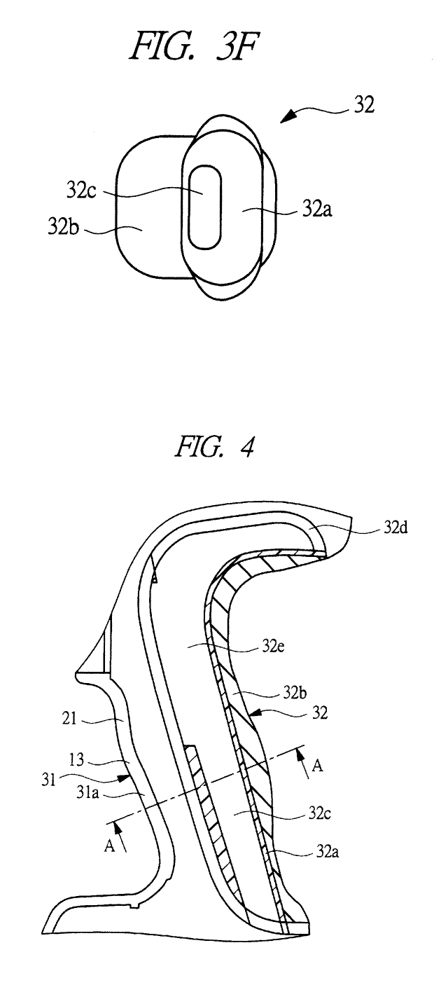

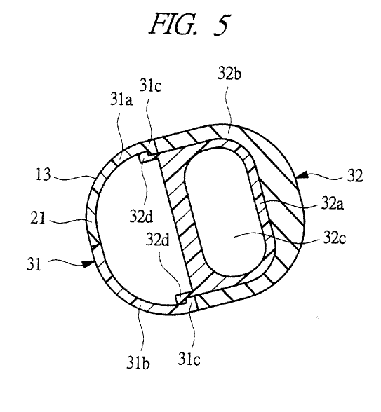

As shown in FIGS. 3A to 5, the cover body 32a has a cylindrical part 32c. Although not illustrated in detail, the cylindrical part 32c accommodates a part of the wiring 23 which connects the battery pack 22 with the electric motor 15. Moreover, on an outer periphery of the cylindrical part 32c, corresponding to the engaging projections 31c of the housing body 31, engaging projections 32d projecting outwardly are integrally provided along all over the circumference. Furthermore, in a portion opposing the trigger 25 of the cylindrical part 32c, a receiving hole 32e being a recess is formed serving as an escape portion for receiving the trigger 25 when the trigger 25 is pushed inside the grip section 13.

The rubber material 32b is formed, by compression molding, to have predetermined uneven thicknesses at predetermined positions. According to the present embodiment, the thickness of the rubber material 32b gradually increases from an end portion on the body portion 12 side of the cover body 32a. The rubber material 32b has a substantially fixed thickness at a portion on a backside of the trigger 25. The rubber material 32b comes to be thickest at a middle portion between the main body 12 and the battery pack 22. That is, the rubber material 32b is formed so as to be thickest at a portion corresponding to a palm of a worker who grips the grip section 13.

This rubber material 32b may be a rubber sponge having hardness of 20 to 60 of ASKAR C defined by The Society of Rubber Industry, Japan Standard: SRIS0101. In particular, it is preferable that the hardness is between 30 and 50. For example, rubber as follows can be used for the rubber sponge: crude rubber (NR sponge), chloroprene rubber (CR sponge), ethylene propylene rubber (EPDM sponge), nitrile rubber (NBR sponge), and silicon rubber (Si sponge).

Thus, according to the present invention, the outer surface of the cover 32 being a part of the grip housing 21 is formed of the rubber material 32b formed by compression molding. If the rubber material 32b is integrally formed with the cover body 32a by two-layer injection molding (two-color injection molding), the rubber material 32b cannot be allowed to have an extremely uneven thickness at the time of molding, which makes it difficult to form the rubber material 32b with a sufficient thickness.

On the other hand, according to the present invention, the rubber material 32b is integrally formed with the cover body 32a by compression molding. As a result, thanks to characteristics of the compression molding, the rubber material 32b is allowed to have suitably uneven thicknesses at proper portions. That is, the rubber material 32b can be allowed to have a sufficient thickness necessary for absorbing vibration caused by the electric motor 15 and the speed reduction mechanism 16 as well as reaction added through the tip tool 19, etc. during work using the impact driver 11. Therefore, even if the vibration and reaction which are produced during work using the impact driver 11 is transmitted to the grip section 13, the rubber material 32b sufficiently absorbs the vibration and reaction, thereby reducing strain on fingers of the worker who grips the grip section 13.

Moreover, the rubber material 32b is formed such that it is thickest at a portion corresponding to a palm of the worker who grips the grip section 13. Therefore, the grip section can be reliably gripped between an index finger and a thumb of the worker operating the trigger 25. At the same time, the vibration and reaction can be efficiently absorbed in the palm, further effectively reducing the strain on the fingers of the worker who grips the grip section 13.

According to one of conventional power tools, a cover having an outer covering made of a rubber material is fixed to the grip housing body by a fastening member such as a screw. Therefore, the number of components increases and it becomes necessary to assemble and mount these components, thereby increasing the manufacturing cost of the power tool.

In contrast, according to the present invention, the grip housing includes: a first housing including a pair of housing pieces; and a second housing including the elastic body. Further, the first housing holds the second housing by sandwiching the second housing between the pair of housing pieces.

More specifically, as shown in FIG. 5, the cover 32 is sandwiched between a pair of housing pieces 31a and 31b, and is held by the housing body 31. That is, the cover 32 is disposed between the housing pieces 31a and 31b when the pair of housing pieces 31a and 31b is combined. Further, engaging projections 32d of the cover 32 are fitted into the engaging projections 31c of the housing pieces 31a and 31b. In this state, when the housing pieces 31a and 31b are fastened with each other by fastening members such as screws etc. (not shown), the cover 32 is sandwiched between the housing pieces 31a and 31b and is held on the housing body 31.

In this manner, according to the present invention, the grip housing 21 includes: the housing body 31 including the pair of housing pieces 31a and 31b; and the cover 32. Further, the cover 32 is sandwiched between the pair of housing pieces 31a and 31b to be held on the housing body 31. Therefore, the cover 32 can be held by the housing body 31 without using fastening members such as screws, etc. Thus, the fastening members such as screws, etc. and the work for fastening become unnecessary, thereby reducing a manufacturing cost of the impact driver 11.

As shown in FIG. 5, the rubber material 32b also encloses both side surfaces of the cover body 32a with a certain thickness. The outer peripheral portion of the enclosing rubber material 32b is opposed to the engaging projections 32d of the cover 32 with a predetermined gap therebetween. When the cover 32 is held on the housing body 31, the outer peripheral portion of the rubber material 32b enclosing both the side surface portions of the cover body 32a is in contact with the engaging projections 31c of the housing body 31. That is, when the cover 32 is held on the housing body 31, the outer peripheral portion of the rubber material 32b is so disposed as to be able to come in contact with the housing body 31.

Thus, when the grip section 13 is gripped by the worker and the cover 32 receives load in a direction in which the cover 32 is received into the housing body 31, the outer peripheral portion in contact with the engaging projections 31c of the housing body 31 of the rubber material 32b supports the load and thus functions as a damper. Therefore, the feel of gripping the grip section 13 can be made softer. At the same time, the vibration and reaction during work can be more effectively absorbed in the rubber material 32b because of the damper effect, thereby further reducing strain on the fingers of the worker who grips the grip section 13.

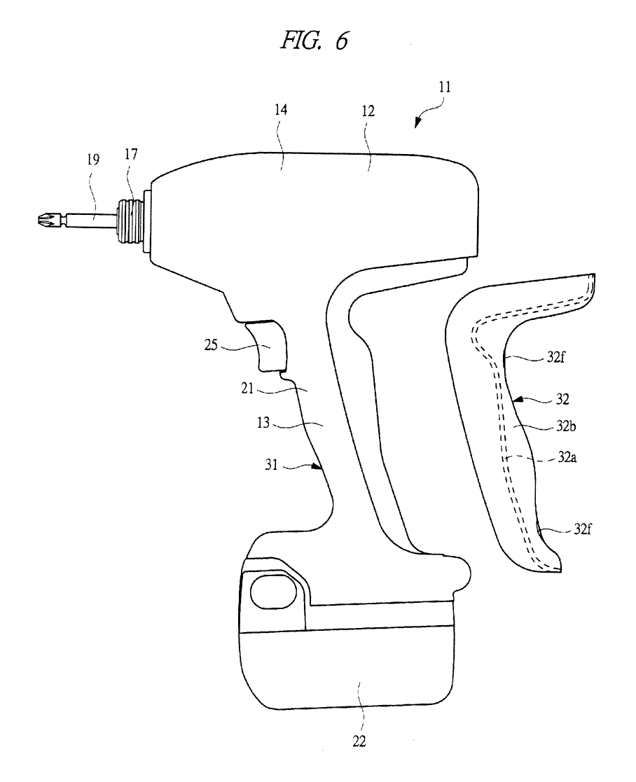

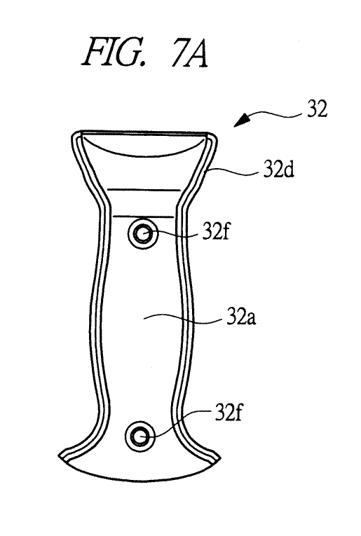

FIG. 6 shows a modification of the impact driver shown in FIG. 1, and is a side view showing such an impact driver whose cover is removed.

According to the impact driver 11 shown in FIG. 1, the cover 32 configuring the grip housing 21 is held such that it is sandwiched between the pair of housing pieces 31a and 31b which constitute the housing body 31.

On the other hand, in a modification example shown in FIG. 6, the cover is fastened to the housing body 31 with screw members (not shown).

In this case, the housing body 31 is formed to be cylindrical by combining the pair of housing pieces 31a and 31b. The wiring 23 connecting a battery pack 22 with an electric motor 15 and a substrate 24 are housed inside the housing body 31. That is, in this modification example, even in a state where the cover 32 is not mounted, the housing body 31 has a closed structure in which the wiring 23 and the substrate 24 are not exposed.

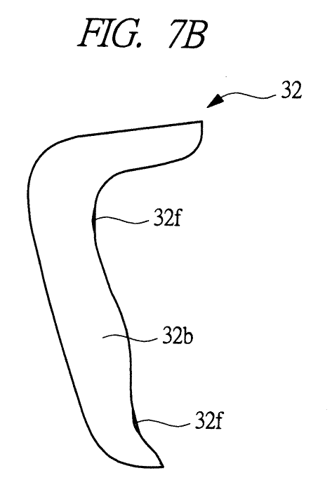

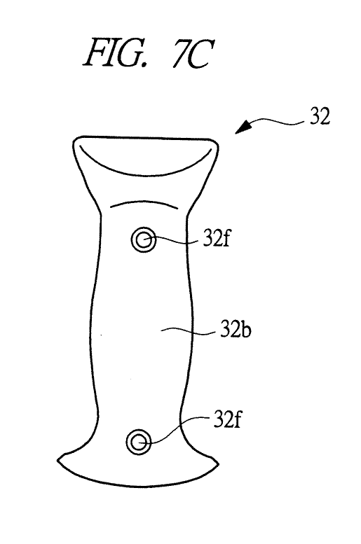

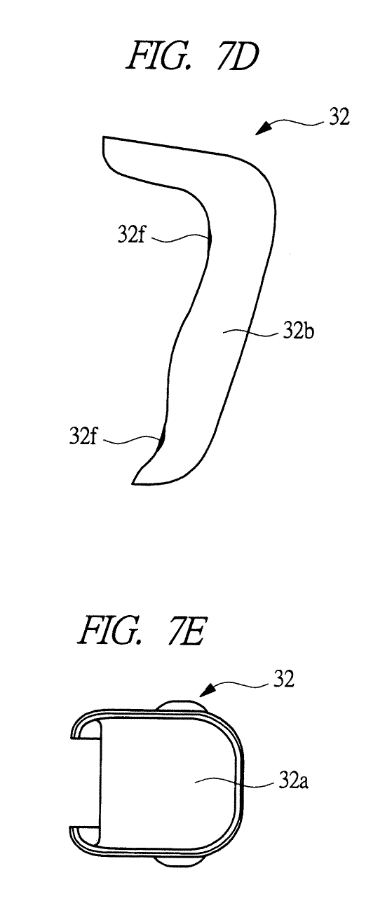

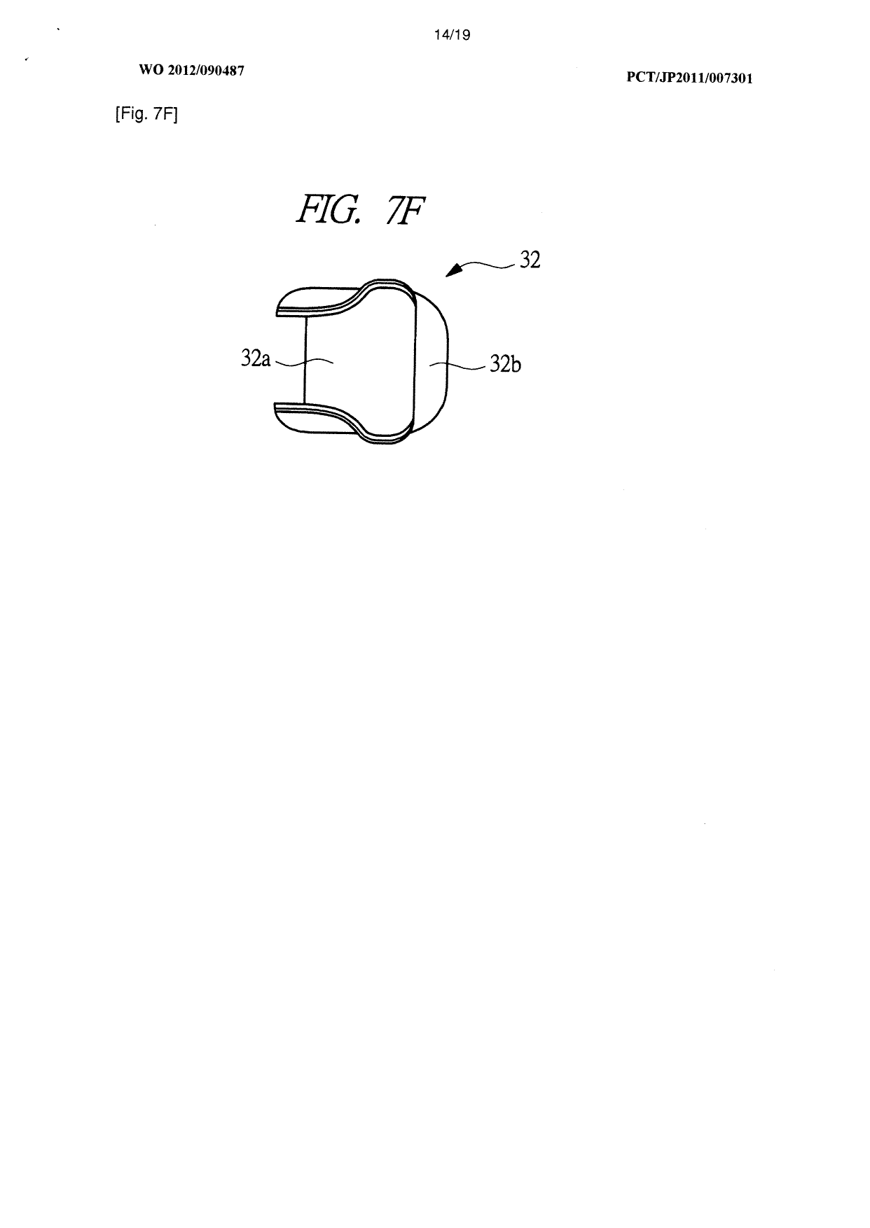

According to that, as shown in FIGS. 7A to 7F, the cover body 32a of the cover 32 is formed so that its cross section is in the shape of U along the outer surface of the rear side of the housing body 31. Further, on the rear side of the grip section 13, the cover body 32a is placed over the housing body 31. Two screw fastening parts 32f are provided in the cover body 32a. The cover 32 is fastened to the housing body 31 with use of screw members (not shown) which are inserted into the screw fastening parts 32f.

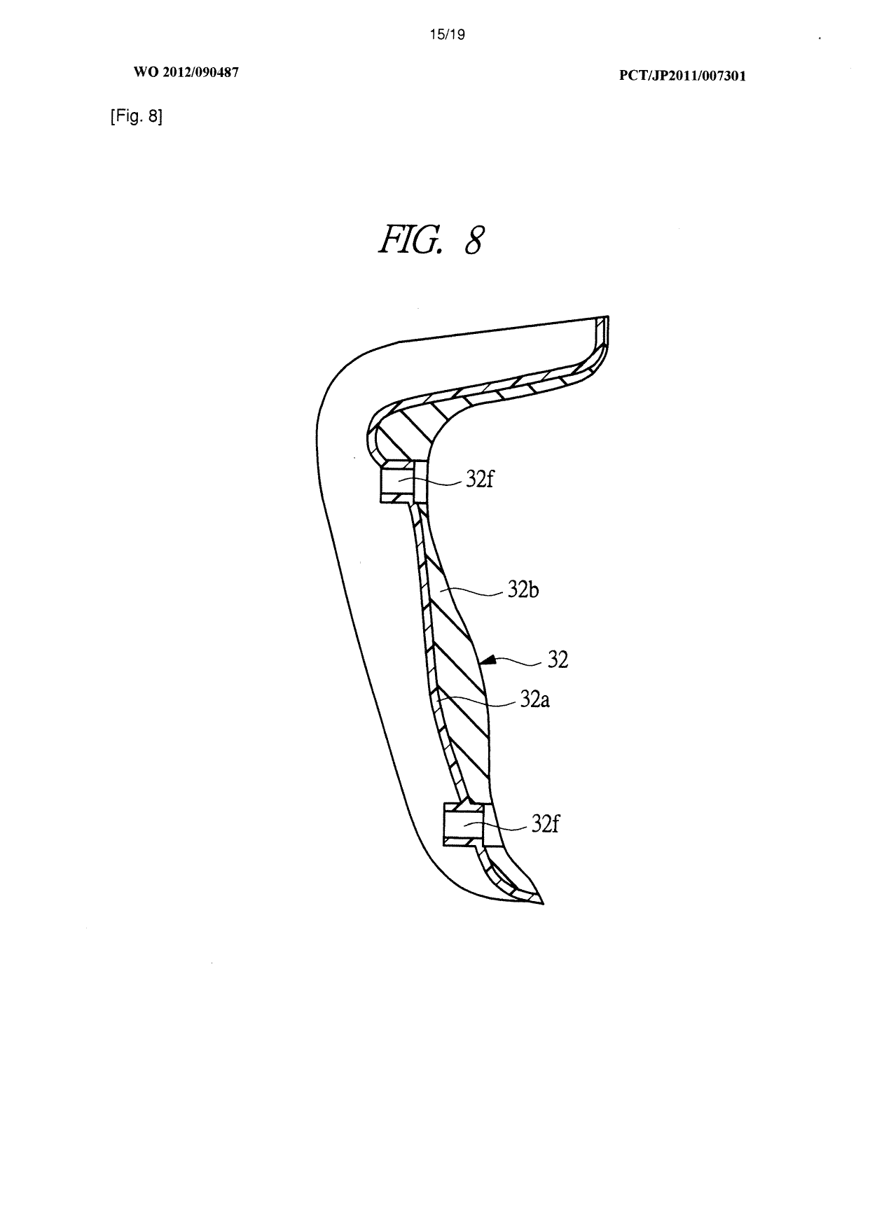

Also in this modification example, the rubber material 32b as an elastic body is integrally formed on the outer surface of the cover body 32a by compression molding. As shown in FIG. 8, the rubber material 32b is formed such that it becomes thickest at two portions, namely, a portion of the grip section 13 on the backside of the trigger 25 and a middle portion between the body portion 12 and the battery pack 22. As a result, the vibration and reaction can be absorbed efficiently by a portion between an index finger and a thumb and a palm portion for manipulating the trigger 25. Moreover, with respect to the cover 32, the screw fastening part 32f is more recessed than the rubber material 32b. Therefore, even when the grip section 13 is gripped by the worker and the rubber material 32b is deformed, the worker's hand does not contact the screw fastening part 32f.

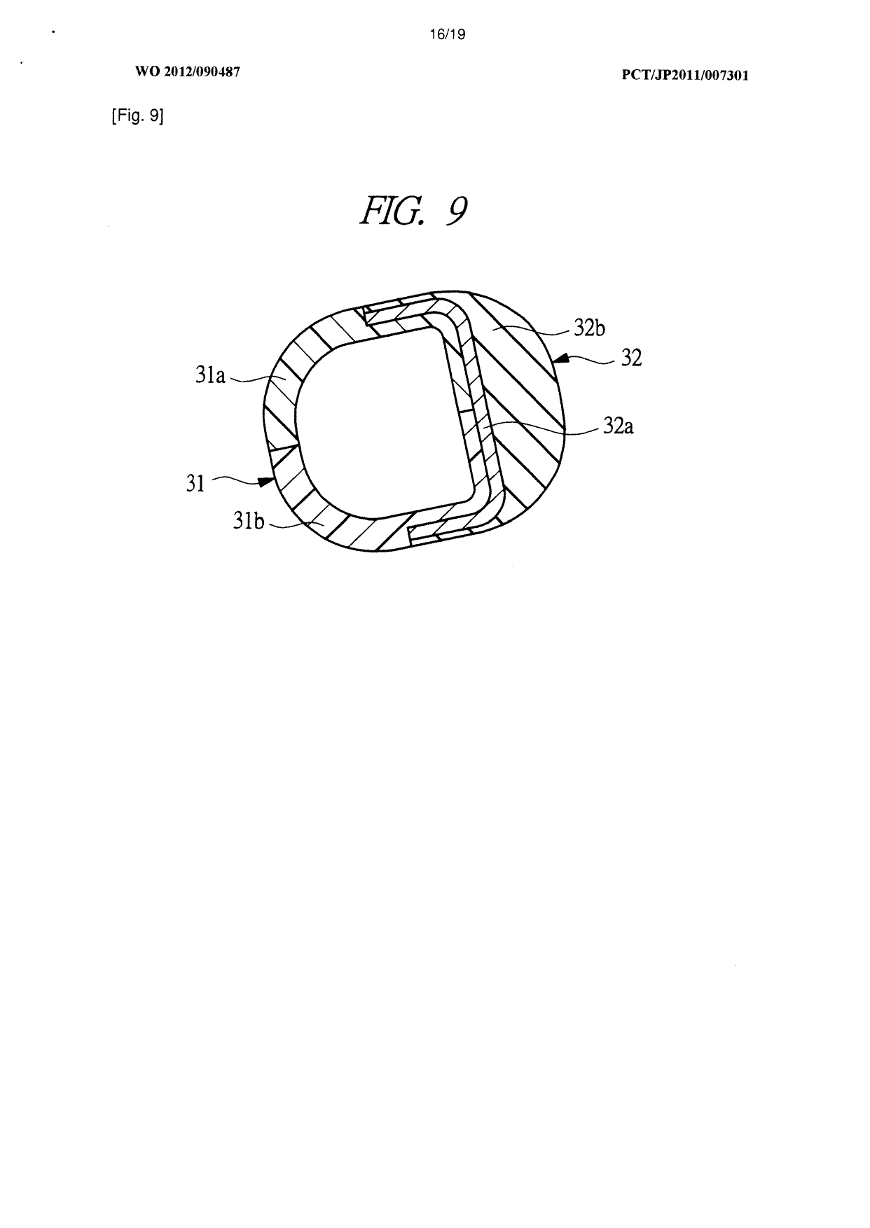

As shown in FIG. 9, according to the present modification example, when the cover 32 is attached to the housing body 31, an outer periphery of the cover body 32a of the cover 32 is allowed to be in direct contact with an uneven part of the housing body 31. As a result, there is provided a portion in the rubber material 32b not in contact with the housing body 31, thereby preventing the rubber material 32b from peeling off the cover body 32a.

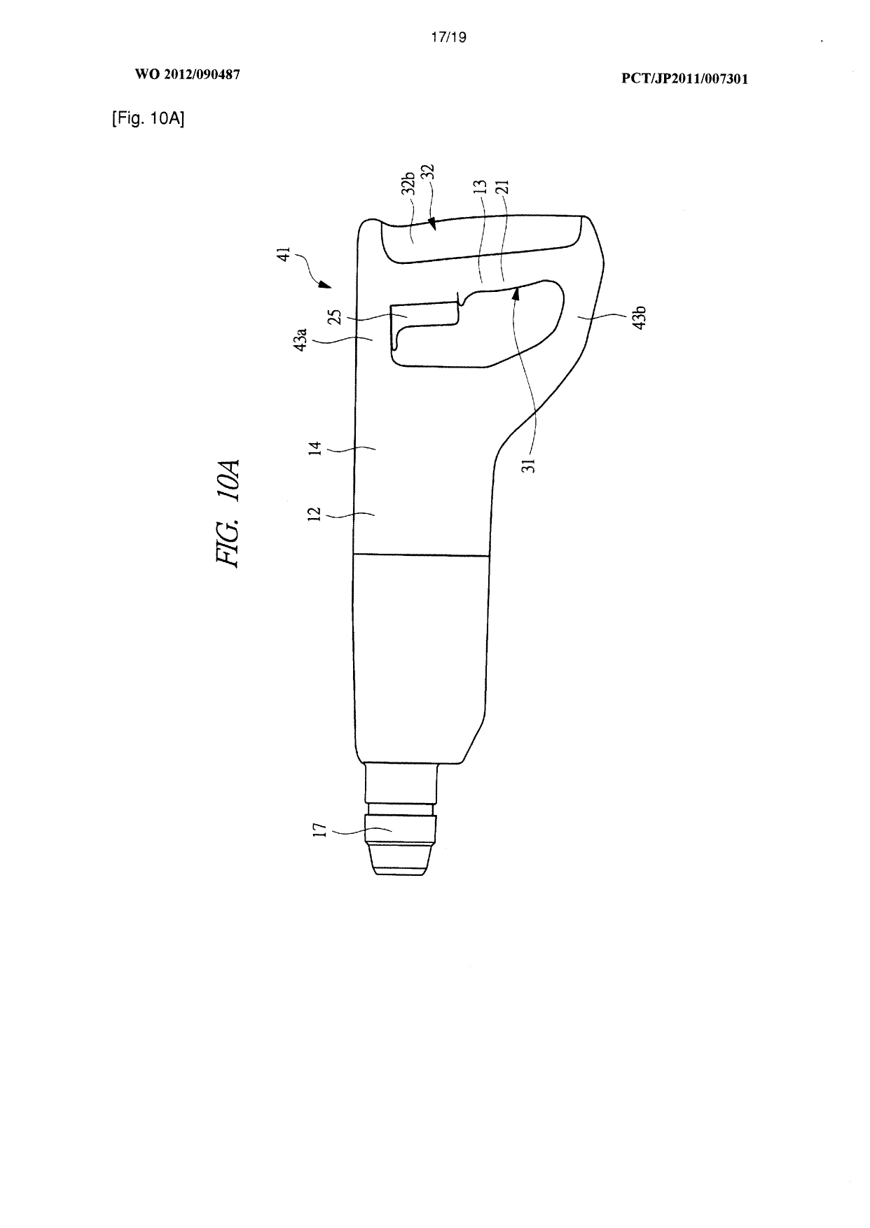

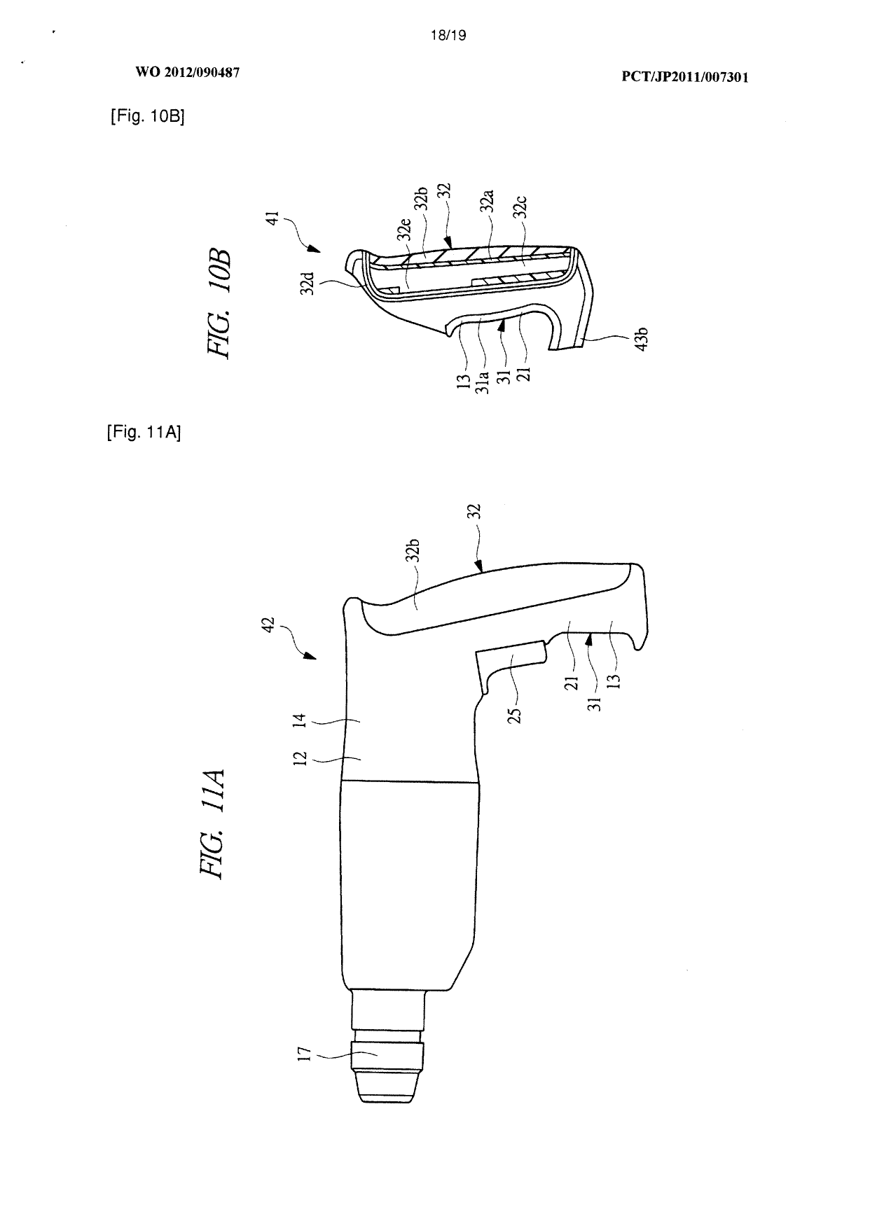

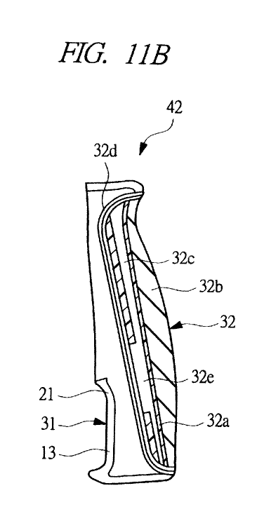

FIG. 10A is a side view of a D-shaped grip electric drill according to another embodiment of the present invention, and FIG. 10B is a cross-sectional view of a grip section of the D-shaped grip electric drill. Moreover, FIG. 11A is a side view of a pistol-shaped grip electric drill according to another embodiment of the present invention, and FIG. 11B is a cross-sectional view of a grip section of the pistol-shaped grip electric drill.

The present invention is also applicable to the D-shaped grip electric drill 41 shown in FIGS. 10A and 10B and to the pistol-shaped grip electric drill 42 shown in FIGS. 11A and 11B.

According to the impact driver 11 shown in FIG. 1, the grip section 13 extends from about a middle part in a direction of axis of the body portion 12 toward a lower side.

On the other hand, according to the D-shaped grip electric drill 41 shown in FIGS. 10A and 10B, the grip section 13 is formed in the shape of D such that it is coupled to a rear end part opposite to the tool holder 17 of the body portion 12 through a pair of upper and lower connecting portions 43a and 43b. Also in this case, a front half of the grip section 13 on the tool holder 17 side includes the housing body 31 integrally formed with the motor housing 14 of the body portion 12. A rear half of the grip section 13 includes a cover 32 held on the housing body 31.

The cover 32 also includes a compression-molded article which is made such that the rubber material 32b as an elastic body is integrally formed by compression molding on a surface of the cylindrical cover body 32a formed with a resin material. Moreover, the rubber material 32b is formed such that the grip section 13 is thickest at a middle portion in its vertical direction.

Meanwhile, in the pistol-shaped grip electric drill 42 of FIGS. 11A and 11B, the grip section 13 is formed in the shape of a pistol such that it extends from the rear end side of the grip section 13 opposite to the tool holder 17 in a direction substantially perpendicular to the direction of axis of the body portion 12. Also in this case, the front half of the grip section 13 on the tool holder 17 side includes a housing body 31 formed integrally with the motor housing 14 of the body portion 12. On the other hand, the rear half of the grip section 13 includes a cover 32 held on the housing main body 31. The cover 32 extends from the rear side of the grip section 13 to the rear side of the body portion 12.

The cover 32 also includes a compression-molded article which is made such that the rubber material 32b as an elastic body is integrally formed on a surface of the cylindrical cover body 32a formed of a resin material. Moreover, the rubber material 32b is formed such that it becomes thickest at a middle portion in the vertical direction of the grip section 13.

Note that, in FIGS. 6 to 11B, the parts corresponding to those described above are denoted by the same reference numerals.

It is needless to say that the present invention is not limited to the foregoing embodiments and various modifications and alterations can be made within the scope of the present invention. For example, in the embodiments described above, as a power tool to which the present invention is applied, the electric power tool having the electric motor 15 as a motor (driving source) has been described. However, the present invention is not limited to the above-described examples. For example, the present invention may be applied to power tools using other motors (driving sources) such as an air tool using an air motor as a motor or an engine tool using an engine.

Also, in the embodiments described above, the impact driver 11 which is an electric power tool includes a battery pack 22 as a power source for the electric motor 15. However, the present embodiment is not limited to this case, and the electric power tool may be one having a power cord instead of the battery pack 22 and may be used by connecting the power cord with a commercial power source.

Further, in the embodiments described above, as power tools, the impact driver 11 and the electric drills 41 and 42 have been described. However, the power tools are not limited to them. The present invention may be applied to other power tools such as a hammer drill, an impact wrench, and a saw, as long as they are power tools to which tip tools are attached to work.

Also, in the embodiments described above, the rubber material 32b has been used as an elastic body. However, the rubber material is not limited to this example, and other elastic bodies such as an elastomer may be used as long as they can be formed by compression molding.

### REFERENCE SIGNS LIST

11 Impact driver (Power tool)
12 Body portion
13 Grip section
14 Motor housing
15 Electric motor (Motor)
16 Speed reduction mechanism
17 Tool holder
18 Impact mechanism
19 Tip tool
21 Grip housing
22 Battery pack
23 Wiring
24 Substrate
25 Trigger
31 Housing body (First housing)
31a, 31b Housing piece
31c Engaging projection
32 Cover (Second housing)
32a Cover body
32b Rubber material (Elastic body)
32c Cylindrical part
32d Engaging projection
32e Receiving hole (Recess)
32f Screw fastening part
41 D-shaped grip electric drill (Power tool)
42 Pistol-shaped grip electric drill (Power tool)
43a, 43b Connecting portion

1. A power tool comprising:
a tool holder to which a tip tool is attached;
a motor for driving the tool holder;
a motor housing for housing the motor; and
a grip housing provided so as to extend from the motor housing, wherein a part of the grip housing is made of an elastic body formed by compression molding.

2. The power tool according to claim 1, wherein
the grip housing includes: a first housing formed of a first resin; and a second housing formed of a second resin, the second housing including an elastic body formed by compression molding, and
the second housing is fixed to the first housing with a screw.

3. The power tool according to claim 1, wherein the first resin and the second resin are in direct contact with each other.

4. The power tool according to claim 1, wherein
the grip housing includes: a first housing formed by combining a pair of housing pieces; and a second housing including an elastic body, and
the second housing is sandwiched between the pair of housing pieces to be held by the first housing.

5. The power tool according to claim 4, wherein the first housing and the second housing are fitted to each other.

6. The power tool according to claim 4, wherein the elastic body is disposed so as to be able to come in contact with the first housing.

7. The power tool according to claim 1, wherein a trigger for starting the motor is provided in the grip housing.

8. The power tool according to claim 7, wherein a recess for housing the trigger is provided in the second housing.
